(19) United States
(12) Patent Application Publication
(10) Pub. No.: US 2025/0345811 A1
(43) Pub. Date: Nov. 13, 2025

(54) OUTDOOR MISTING FAN AND COOLING DEVICE

(71) Applicant: Wenjie LI, Guangzhou (CN)

(72) Inventor: Wenjie LI, Guangzhou (CN)

(21) Appl. No.: 18/763,162

(22) Filed: Jul. 3, 2024

(30) Foreign Application Priority Data
May 13, 2024 (CN) 202410590452.3

(51) Int. Cl. B05B 3/02; B05B 7/00

(52) U.S. Cl. CPC B05B 3/0204; B05B 7/0075

(57) ABSTRACT

An outdoor misting fan and a cooling device. The outdoor misting fan includes a fan atomization assembly including a atomizer and a lower housing, an installation assembly including a cylinder connected with the lower housing, an elastic clamping piece sleeved outside the cylinder and a guiding member, and a battery located inside the cylinder and electrically connected to the fan atomization assembly. The elastic clamping piece can adapt to various types of water storage bottles, and during assembly, the cylinder is directly placed inside the water storage bottle, which increases the available space for the battery. Users do not need to carry bottle when carrying the outdoor misting fan, as commercially available water bottles can be easily fitted and used as a handle. The internal cylinder not only provides additional space for the battery but also facilitates water extraction, which meet the users' needs for long-term and portable usage.

### CROSS-REFERENCE TO RELATED APPLICATIONS

The present disclosure claims priority to Chinese Patent Application No. 202410590452.3, filed on May 13, 2024. The content of aforesaid application is incorporated herein by reference.

### FIELD

The present disclosure relates to the technical field of misting fan, and in particular to an outdoor misting fan and a cooling device.

### BACKGROUND

Fan is a physical cooling tool that is driven by electricity. The fan converts electrical energy into mechanical energy that drives the fan blades to rotate, and provides an airflow through the fan blades. The evaporation of sweat on the user's body surface is accelerated by increasing the air flow rate, thereby a cooling experience for the user is provided. With the continuous development of technology, the size of fans has been reduced, forming handheld fans that are easy for users to carry outdoors and are widely praised. Based on handheld fans, manufacturers are constantly improving handheld fans to provide more functions, such as multi-speed adjustment, misting cooling, etc., to further provide users with better using experiences.

In the prior art, a handheld fan with a misting cooling function is provided with a water storage bottle for atomization, which requires users to reserve a large space when carrying the fan. At the same time, due to the overall miniaturization design limitation of the handheld fan, the size of the water storage bottle limits the design size of the battery of the misting fan, resulting in a limited endurance of the misting fan. When used outdoors, the fan cannot meet the user's needs for long-term use and convenient operation.

Therefore, the prior art still needs to be improved and developed.

### SUMMARY

The present disclosure proposes an outdoor misting fan and a cooling device to solve the problem in the prior art that the existing outdoor misting fan is not portable enough and does not have long-term battery resulting from the fact that the overall size of the outdoor misting fan is limited due to the need of holding and carrying, while the water storage bottle occupies a large space that reduces the design size of the misting fan battery. The prior art cannot meet the user's needs for long-term outdoor use and is not convenient to operate.

The present disclosure provides an outdoor misting fan, which includes:
A fan atomization assembly, the fan atomization assembly includes an atomizer and a lower housing;
An installation assembly, the installation assembly includes:
   A cylinder, the cylinder is hollow inside and has a sealed outer wall, and one end of the cylinder is fixedly connected to the lower housing;
   A clamping piece, the clamping piece is an elastic clamping piece, and is fixedly sleeved on an outer side of the cylinder corresponding to the lower housing, the clamping piece is configured to be connected with a bottle body, the cylinder is sleeved inside the bottle body, and the bottle body is used as a handle and a base;
   A guiding member, the guiding member is arranged on the outer side of the cylinder and has one end connected to the atomizer;
A battery, the battery is sleeved inside the cylinder and is electrically connected to the fan atomization assembly.

In the outdoor misting fan, a plurality of first mounting tenons protrude from an inner side of the clamping piece, and the plurality of first mounting tenons are circumferentially arranged along a first preset angle and spaced with a preset distance;

Or, a plurality of second mounting tenons protrude from the inner side of the clamping piece, and the plurality of second mounting tenons are continuously arranged along a second preset angle;

Or, a plurality of third mounting tenons protrude from the inner side of the clamping piece, and the plurality of third mounting tenons are arranged in an array along a third preset angle.

In the outdoor misting fan, the lower housing includes a mounting tube, the cylinder is sleeved in the mounting tube, and a mounting groove is provided in the lower housing corresponding to the mounting tube, and the mounting groove is continuously arranged along an intersecting curved surface between the lower housing and the mounting tube;

A limiting plate is arranged on one end of the cylinder corresponding to the lower housing, and the limiting plate protrudes outward from the one end of the cylinder, an extending portion is formed by bending an edge of the limiting plate, the limiting plate, the extending portion and the cylinder are formed integrally;

Latch teeth are arranged on the extending portion, and the latch teeth are engaged in the mounting groove.

In the outdoor misting fan, a diameter of the extending portion is the same as a diameter of the mounting tube, and a plurality of locking grooves are circumferentially provided on an inner side of the extending portion;

A plurality of latch tenons are provided on an outer side of the clamping piece, and the latch tenons are correspondingly fitted in each locking groove, and one side of the latch tenons is in contact with an end of the mounting tube;

The latch teeth are formed by bending edges of the locking grooves, and a shape of the mounting groove is adapted to a shape of the latch teeth.

In the outdoor misting fan, a plurality of limiting tenons are provided in the lower housing corresponding to the limiting plate, and the plurality of limiting tenons are engaged with a side of the limiting plate away from the extending portion.

In the outdoor misting fan, the installation assembly further includes:
A storage tray, a mounting pillar is arranged on one side of the storage tray, and the mounting pillar is removably connected to a connecting pile arranged at an end of the cylinder;
The storage tray is in a plate shape, and a plurality of first positioning holes are circumferentially provided on the storage tray, the plurality of first positioning holes are arranged through an edge of the storage tray, and the first positioning holes are configured to fix the guiding member.

In the outdoor misting fan, a positioning plate is arranged on a side of the cylinder corresponding to the connecting pile, the positioning plate is arranged perpendicularly to a bottom plate of the cylinder, and a second positioning hole is arranged on the positioning plate, the second positioning hole is configured to fix the guiding member;

An installation plate is arranged on one end of the mounting pillar, the installation plate is arranged parallel to the bottom plate of the cylinder, and a clamping groove is arranged on the installation plate, when the connecting pile is connected to the mounting tube, the positioning plate penetrates and engages with the clamping groove.

In the outdoor misting fan, the fan atomization assembly further includes:
Fan blades, the fan blades are arranged opposite to the atomizer, and the battery is electrically connected to the fan blades and the atomizer, respectively;
A control element, the control element is fitted and arranged on the lower housing, and the control element is electrically connected to the atomizer, the fan blades, and the battery.

In the outdoor misting fan, the fan atomization assembly further includes:
A core cylinder, the atomizer and the fan blades are fixedly arranged on both ends of the core cylinder;
A front ventilation hood, the front ventilation hood is arranged on one end of the core cylinder;
A rear ventilation hood, the rear ventilation hood is arranged on another end of the core cylinder, and the rear ventilation hood is engaged with the front ventilation hood;
An upper housing, the upper housing is buckled and matched with the lower housing; the front ventilation hood is fitted in one end between the upper housing and the lower housing; the rear ventilation hood is fitted in another end between the upper housing and the lower housing.

The present disclosure also provides a cooling device, the cooling device includes the outdoor misting fan described in any one of the above.

The beneficial effects of the present disclosure are as follows: by providing a hollow cylinder with a sealed outer wall, and providing an elastic clamping piece on the outer side of the cylinder corresponding to a lower housing of a fan atomization assembly, the present disclosure can adapt to various types of water bottles through the elastic clamping piece, and directly place the cylinder in the water bottle when assembled, thereby increasing the installation space of the battery. Further, users do not need to carry bottles when carrying an outdoor misting fan because drinking water bottles sold on the market can be adapted, which improves portability while facilitating outdoor use and obtaining water sources. The installed bottle can be directly used as a handle, thus the user's needs for long-term use and portability is met.

### BRIEF DESCRIPTION OF THE DRAWINGS

FIG. 1 is an exploded view of the structure of an outdoor misting fan according to the present disclosure;

FIG. 2 is a perspective view of the structure of an outdoor misting fan according to the present disclosure;

FIG. 3 is a schematic diagram of installing an installation assembly with a lower housing in an outdoor misting fan according to the present disclosure;

FIG. 4 is a schematic diagram of disassembling an installation assembly from a lower housing in an outdoor misting fan according to the present disclosure;

FIG. 5 is a schematic diagram of the installation of a clamping piece in an outdoor misting fan according to the present disclosure;

FIG. 6 is an exploded view of the structure of an installation assembly in an outdoor misting fan according to the present disclosure;

FIG. 7 is a perspective view of a clamping piece in an outdoor misting fan according to a first embodiment of the present disclosure;

FIG. 8 is a perspective view of a clamping piece in an outdoor misting fan according to a second embodiment of the present disclosure.

### DETAILED DESCRIPTION OF EMBODIMENTS

In order to make the purpose, technical solution and effect of the present disclosure clearer, the present disclosure is further described in detail below with reference to the accompanying drawings and embodiments. It should be understood that the embodiments described here are only used to explain the present disclosure and are not intended to limit the present disclosure.

It should be noted that if there are directional instructions (such as up, down, left, right, front, back . . . ) in the embodiments of the present disclosure, the directional instructions are only used to explain the relative positional relationship, movement conditions, etc. between the components in a certain posture (as shown in the accompanying drawings), if the posture changes, the directional indications will also change accordingly.

In addition, if there are descriptions involving “first”, “second”, etc. in the embodiments of the present disclosure, the descriptions of “first”, “second”, etc. are only used for descriptive purposes and cannot be understood as indicating or suggesting their relative importance or implicitly indicating the number of the indicated technical features. Therefore, the features defined as “first” or “second” may explicitly or implicitly include at least one of the features. In addition, the technical solutions between the various embodiments can be combined with each other, but should be able to implement for those skilled in the art. When the combination of technical solutions is contradictory or cannot be implemented, it should be deemed that such a combination of technical solutions does not exist and is not within the scope of protection required by the present disclosure.

In the prior art, a handheld fan with a misting cooling function is provided with water bottle for supplying atomization, which requires users to reserve a large space when carrying the fan. At the same time, due to the overall miniaturization design limitation of the handheld fan, the size of the water bottle limits the design size of the battery of the misting fan, resulting in the misting fan's endurance being limited. When used outdoors, the fan cannot meet the user's needs for long-term use and convenient operation.

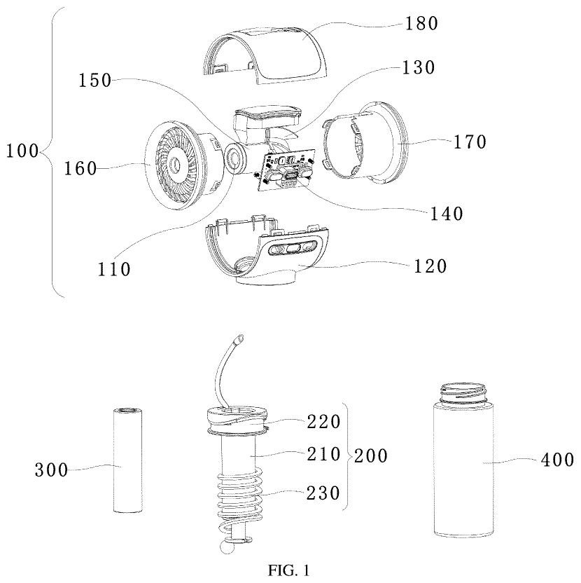

Based on the above problems in the prior art, the present disclosure provides an outdoor misting fan. As shown in FIG. 1, the outdoor misting fan includes: a fan atomization assembly 100, an installation assembly 200, and a battery 300. The fan atomization assembly 100 includes an atomizer 110 and a lower housing 120. The installation assembly 200 includes: a cylinder 210, a clamping piece 220, and a guiding member 230. The cylinder 210 is hollow inside and has a sealed outer wall, and one end of the cylinder 210 is fixedly connected to the lower housing 120. The clamping piece 220 is an elastic clamping piece 220, and the clamping piece 220 is fixedly sleeved on an outer side of the cylinder 210 corresponding to the lower housing 120. The clamping piece 220 is used to connect with a bottle body 400, and the cylinder 210 is sleeved inside the bottle body 400. The bottle body 400 is used as a handle and a base. The guiding member 230 is arranged on the outer side of the cylinder 210, and has one end connected to the atomizer 110. The battery 300 is arranged inside the cylinder 210, the battery 300 is electrically connected to the fan atomization assembly 100.

The present disclosure provides the hollow cylinder 210 with sealed outer wall and the elastic clamping piece 220 on the outer side of the cylinder 210 corresponding to the lower housing 120 of the fan atomization assembly 100. The elastic clamping piece 220 can be used to adapt to various types of water storage bottle, and the cylinder 210 can be directly placed in the water storage bottle during assembly, thereby increasing the installation space of the battery 300 and resulting in the fact that user does not need to carry the bottle body 400 when carrying the outdoor misting fan as any bottle of drinking water sold on the market can be adapted and installed. The installed bottle body 400 is used directly as a handle. The internal cylinder 210 not only increases the installation space of the battery 300, but also facilitates the external guiding member 230 to collect water. The outdoor misting fan is portable, easy to use outdoors and obtain water, meeting the needs of users for long-term use.

In the above embodiment, as shown in FIG. 1, the main body of the outdoor misting fan of the present disclosure is composed of the fan atomizing assembly 100, the installation assembly 200 and the battery 300, the fan atomizing assembly 100 is the main structural component for generating wind force and spraying mist. In the present embodiment, in order to ensure the fan having the function of misting, the fan atomizing assembly 100 must include the atomizer 110. Correspondingly, a water storage structure for providing water source for the atomizer 110 should also be guaranteed. In the present embodiment, the water storage structure is the bottle body 400, which is a common bottle body 400 in the prior art, such as a mineral water bottle, a beverage bottle, etc. In the existing technology, the drinking water industry uniformly sets the caliber of 500 ml and 350 ml drinking water bottles to 30 mm, ensuring that all bottles can be combined with a 32 mm caliber cap, with a pitch of 3 mm and a lead of 9 mm. The calibers of drinking water of some brands are 35 mm, 38 mm, etc. Based on this industry standard, the clamping piece 220 in the installation assembly 200 in the present disclosure is preset to be compatible with common bottle body 400 in the market. When in actual use, the user only needs to carry the main body of the outdoor misting fan of the present disclosure, and the bottle body 400 can be obtained by temporary purchase, which is convenient for the user to carry and for the user to replace and obtain the water source required for misting.

In the present embodiment, after the bottle body 400 is obtained, the bottle body 400 is combined with the clamping piece 220. During the combination process, the cylinder is correspondingly sleeved inside the bottle body 400 to form a strong combination. After the combination process, the center of gravity of the outdoor misting fan is located inside the bottle body 400, the bottle body 400 can be used as a handle or a base. For example, the user can use the outdoor misting fan in a certain angle while moving by holding the bottle body 400, or place the bottle body 400 on a fixed plane as a base. In the present disclosure, the connection relationship between the clamping piece 220 and the bottle body 400 and the position relationship between the cylinder 210 and the bottle body 400 are defined when the outdoor misting fan is combined with the bottle body 400. However, the specific size and shape of the bottle body 400 are not limited. Any combination of a bottle with the same function and the outdoor misting fan of the present disclosure should fall within the protection scope of the present disclosure.

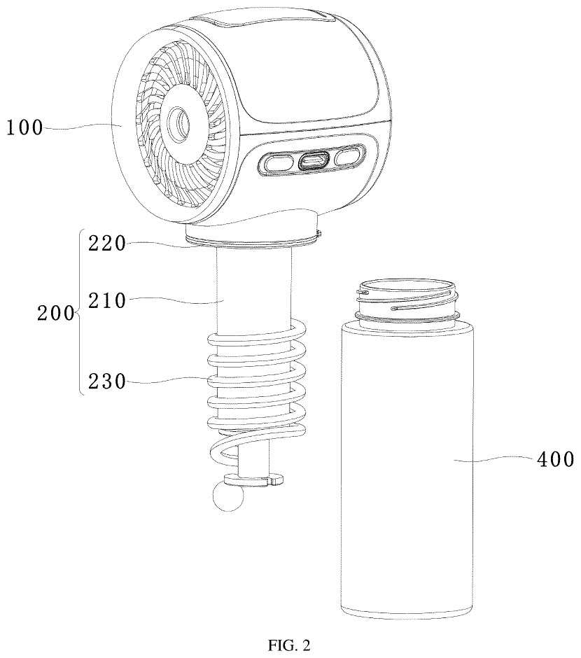

Furthermore, the installation assembly 200 includes the cylinder 210, the clamping piece 220 and the guiding member 230, the outer side of the cylinder 210 is sealed. The cylinder 210 can be made of silicone, plastic, stainless steel or other metal materials in actual arrangement. One end of the cylinder 210 is connected to the fan atomization assembly 100 during specific installation (as shown in FIG. 2), and an opening is provided on one end of the cylinder 210 corresponding to the fan atomization assembly 100. The battery 300 is sleeved inside the cylinder 210 along the opening during installation. The clamping piece 220 is provided on the outer side of the cylinder 210. In the present embodiment, in order to enable the clamping piece 220 to adapt to the bottle bodies 400 with different diameters, the clamping piece 220 is made of elastic material, such as rubber or other materials. The clamping piece 220 is fixedly sleeved on the outer side of the cylinder 210 corresponding to the lower housing 120. The guiding member 230 is arranged on the outer side of the cylinder 210, and one end of the guiding member 230 is connected to the atomizer 110.

When in use, please refer to FIG. 2, parts of the cylinder corresponding to the inner side of the bottle body 400 are all sealed when the bottle body 400 storing water is combined with the clamping piece 220, which can prevent water from entering the inner side of the cylinder 210 and contacting the battery 300. At the same time, the internal space of the bottle body 400 forms a storage space for the cylinder 210, which greatly increases the design space of the battery 300, so that the rated power of the battery 300 can be greatly increased to meet the needs of continuous using. Furthermore, the water bottles in the prior art are designed with relevant structures that are easy to hold with one hand. Therefore, when the bottle body 400 is combined with the long-endurance outdoor misting fan of the present disclosure, the bottle body 400 forms the handle part of the long-endurance outdoor misting fan, which also has the function of providing a water source of misting, the advantages of the water bottles in the prior art are fully utilized.

In the present embodiment, the guiding member 230 in the installation assembly 200 guides the water in the bottle body 400 to the atomizer 110. Further, the guiding member 230 is arranged around the outer side of the cylinder 210, and has one end being connected to the atomizer 110. In the present embodiment, the atomizer 110 can be set as various types, and the guiding member 230 can be set to different types correspondingly. Those skilled in the art can adjust the setting according to actual design requirements and all these adjustments should all fall within the scope of protection of the claims attached to the present disclosure.

In the present embodiment, since the opening in the cylinder 210 faces the fan atomization assembly 100, the battery 300 has space to establish electrically connections with electrical components inside the cylinder 210, such as the battery 300 being electrically connected to the atomizer 110, the battery 300 being electrically connected to other functional components in the fan atomization assembly 100, etc., to meet the power demand of the long-endurance outdoor misting fan. At the same time, in the present embodiment, the battery 300 may be provided in a variety of forms, such as cylindrical lithium batteries with different diameters, and soft-pack batteries, polymer batteries, nickel-hydrogen batteries that having of predetermined shapes, and alkaline battery lamps. Correspondingly, the shape of the inner cavity of the cylinder 210 should be adapted to the shape of the battery 300 to ensure that the battery 300 can be stably engaged inside the cylinder 210, and to ensure the stability of the center of gravity of the long-endurance outdoor misting fan when held. In addition, in some embodiments, the battery 300 may be replaceable, such as being replaced with the battery 300 having the same specification, or a disposable battery having the same specification, etc.

In another embodiment of the present disclosure, in addition to having elastic deformation properties and being able to adapt to different types of bottle bodies 400, the clamping piece 220 can also be provided with various types for ensuring the stable combination of the clamping piece 220 and the bottle body 400.

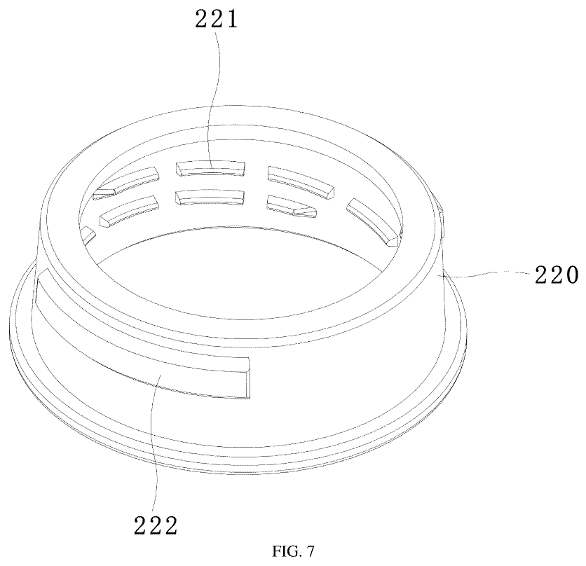

In a first embodiment of the present disclosure, as shown in FIG. 7, a plurality of first mounting tenons 221 are arranged to protrude from the inside of the clamping piece 220. The plurality of first mounting tenons 221 are arranged with a first preset angle, and adjacent first mounting tenons 221 are arranged with an interval having a preset distance. During actual installation, the plurality of first mounting tenons 221 surround the inner side of the clamping piece 220, and guide and engage the bottle neck when the clamping piece 220 is combined with the bottle neck of a commercial drinking water bottle body 400.

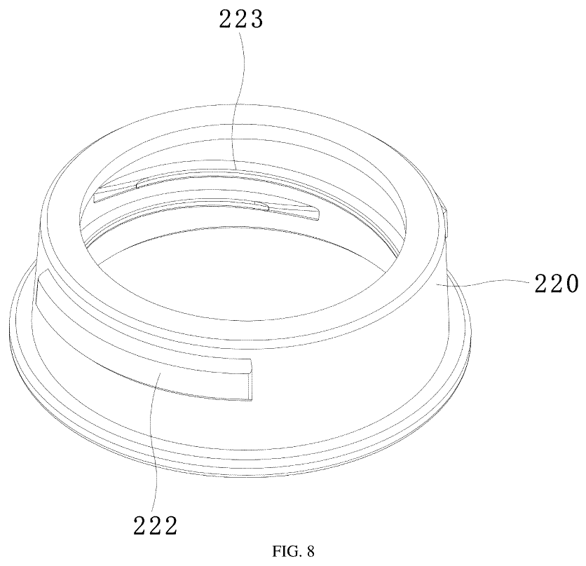

In a second embodiment of the present disclosure, as shown in FIG. 8, a second mounting tenon 223 is arranged to protrude from the inner side of the clamping piece 220. The second mounting tenon 223 is continuously arranged with a second preset angle, and forms a thread pattern. When installed, the second mounting tenon 223 surrounds the inner side of the clamping piece 220, and guides and provides thread that adapts to the bottle neck when the clamping piece 220 is combined with the bottle neck of a commercial water bottle.

In a third embodiment of the present disclosure, a plurality of third mounting tenons are arranged to protrude from the inner side of the clamping piece 220. The plurality of third mounting tenons are arranged in an array with a third preset angle. The third mounting tenons can be in a variety of shapes such as a hemispherical shape and a triangular tooth shape, which are not limited in the present disclosure, and those skilled in the art can set according to actual usage requirements.

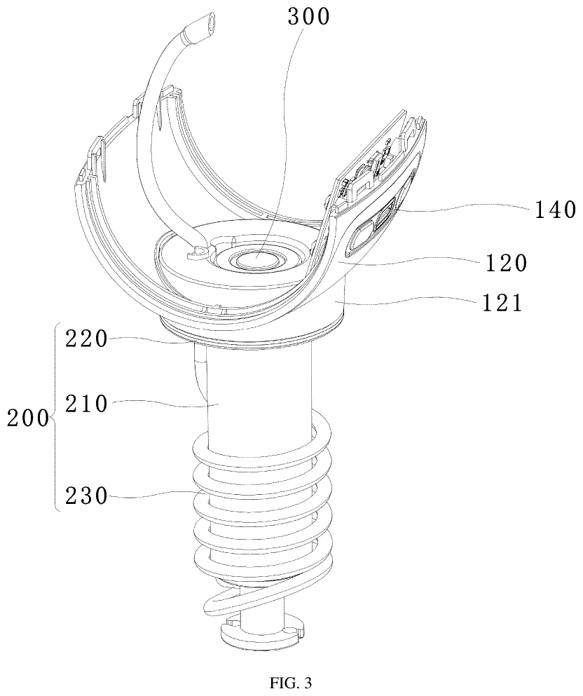

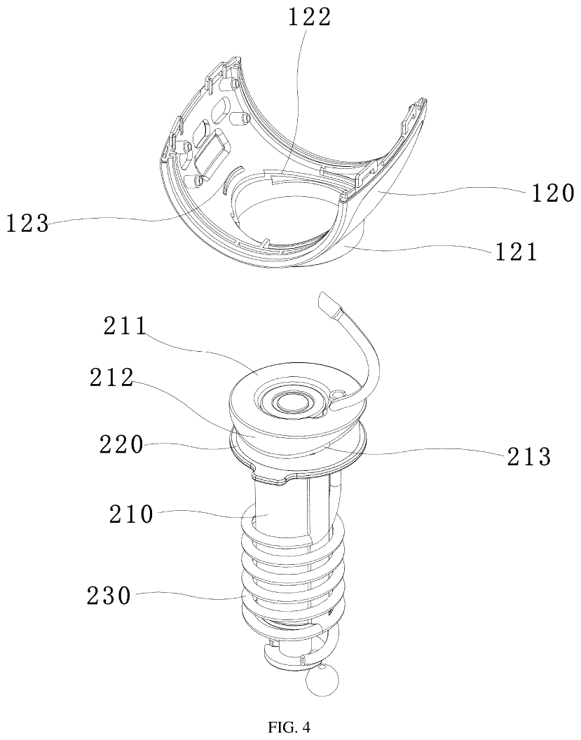

In another possible embodiment of the present disclosure, as shown in FIG. 3 and FIG. 4, in order to assemble the fan atomization assembly 100 and the installation assembly 200, in the present embodiment, the lower housing 120 of the fan atomization assembly 100 should include an mounting tube 121, and the cylinder 210 is sleeved in the mounting tube 121. Further, a limiting plate 211 is provided on one end of the cylinder 210 corresponding to the lower housing 120, and the limiting plate 211 is arranged to protrude outward from the end of the cylinder 210. The limiting plate 211 is used to limit the clamping member 220 and the installation position. In the present embodiment, an extending portion 212 is arranged by bending the edge of the limiting plate 211. When assembled, the cylinder 210 is sleeved in the mounting tube 121, and one end of the cylinder 210 with the limiting plate 211 and the extending portion 212 is located inside the lower housing 120, forming a structural state of contact and limiting.

Further, as shown in FIG. 4, a mounting groove 122 is provided inside the lower housing 120 corresponding to the mounting tube 121, and correspondingly, latch teeth 213 are provided on the extending portion 212 to be engaged into the mounting groove 122. Under the combination of the latch teeth 213 and the mounting groove 122, the cylinder 210 and the mounting tube 121 form an inverted structure, and when the limiting plate 211 of the cylinder 210 is limited by other functional structures in the fan atomization assembly 100, the effect of fixing the cylinder 210 to the lower housing 120 can be achieved.

In order to make the combination of the cylinder 210 on a mounting pillar 242 more stable and prevent swinging, in the present embodiment, the mounting groove 122 is arranged along an intersecting curved surface between the lower housing 120 and the mounting tube 121, and the mounting groove 122 should be continuously arranged. Correspondingly, the latch teeth 213 on the extending portion 212 are arranged along a preset curvature, and the preset curvature is adapted to the intersecting curved surface between the lower housing 120 and the mounting tube 121. In one embodiment, as shown in FIG. 1, the contour of the fan atomization assembly 100 is cylindrical, so the intersecting position between the lower housing 120 and the mounting tube 121 is actually an ellipse with curvature. Therefore, when the mounting groove 122 is arranged along the ellipse-with-curvature portion, the engaged latch teeth 213 form a hooking structure with the mounting groove 122, and the surface change of the connecting portion can effectively limit the swing of the cylinder 210 and provide an effect of facilitating assembly.

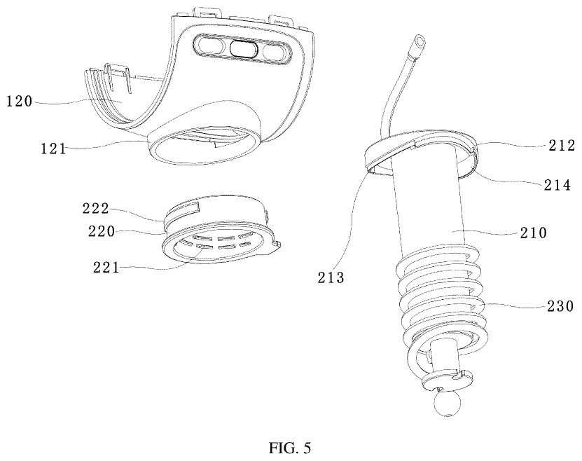

In another possible implementation of the present disclosure, as shown in FIG. 5, in order to lock the position of the clamping piece 220, in the present embodiment, a plurality of locking grooves 214 are circumferentially provided on the inner side of the extending portion 212. The plurality of locking grooves 214 are recessed inside the extending portion 212. Correspondingly, a plurality of latch tenons 222 are provided on the outer side of the clamping piece 220, and the plurality of latch tenons 222 are adapted to the plurality of locking grooves 214. While installing the clamping piece 220, the latch tenons 222 on the clamping piece 220 are first sleeved correspondingly into the locking grooves 214 on the extending portion 212, and then the cylinder 210 is assembled with the lower housing 120 so that the cylinder 210 penetrates buckles on one end of the mounting tube 121. At this time, since the inner diameter of the extending portion 212 is the same as the inner diameter of the mounting tube 121, the upper part of the latch tenons 222 on the clamping piece 220 is locked by the limiting plate 211, and the lower part is locked by the end of the mounting tube 121, a fixed installation effect of the clamping piece 220 is formed.

Based on the above embodiments, as shown in FIG. 5, when the locking groove 214 is provided, the latch teeth 213 can be bent along the edge of the locking groove 214, and the shape of the mounting groove 122 on the mounting tube 121 is adapted to the shape of the latch teeth 213, thereby further improving the stability of the cylinder 210 after installation and achieving more stable combination and providing direction alignment effect.

Further, as shown in FIG. 4, during the installation process of the cylinder 210, after the latch teeth 213 on the extending portion 212 are engaged with the mounting groove 122 on the mounting tube 121, in addition to fixing the components by the pressure from the components in the fan atomization assembly 100, fixed engagement can be achieved by providing a plurality of limiting tenons 123 on the lower housing 120 corresponding to the limiting plate 211. In the present embodiment, as shown in FIG. 3 and FIG. 4, the installation process of the cylinder 210 is achieved by penetrating downward through the mounting tube 121 from the top of the lower housing 120. By arranging the plurality of limiting tenons 123 in the lower housing 120, space is provided for the installation of the limiting plate 211 and the extending portion 212 on the cylinder 210 by cooperating with the slight elastic deformation of the lower housing 120. After the cylinder body 210 is installed to the preset position, the force applied to the lower housing 120 is cancelled to reset the lower housing 120. At this time, the plurality of limiting positions are engaged with the side of the limiting plate 211 away from the extending portion 212, thereby forming a more stable installation state for the cylinder 210.

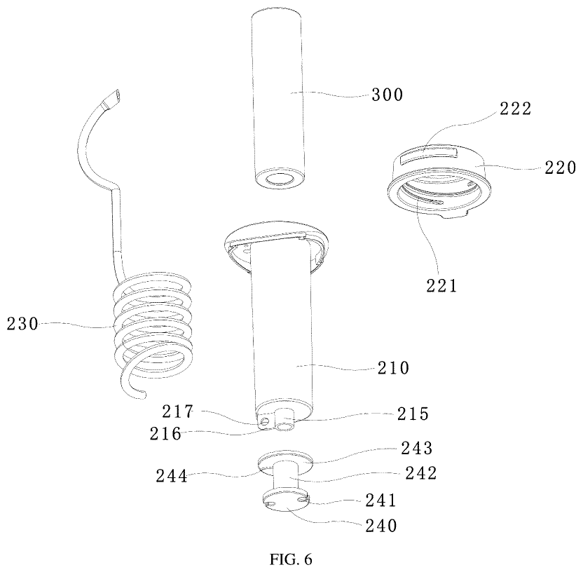

In another possible implementation of the present disclosure, as shown in FIG. 6, in order to install and fix the guiding member, besides arrange the guiding member around the outer side of the cylinder 210, a storage tray 240 is further provided in the installation assembly 200. The storage tray 240 is disposed on one end of the cylinder 210 away from the fan cooling assembly. When installed, the storage tray 240 is an optional component that can be detachably connected to the cylinder 210. Further, a plurality of first positioning holes 241 are arranged on the storage tray 240. The diameter of the first positioning holes 241 is adapted to the diameter of the guiding member. Therefore, by penetrating one end of the guiding member into the first positioning holes 241, a limiting effect of the angle and position of the end of the guiding member is achieved, effectively ensuring the stable operation of the guiding member for water absorption and guiding, and further ensuring that the end of the guiding member is set toward the bottom of the bottle body 400 to ensure that the water can be obtained continuously when spraying mist.

In another possible implementation of the disclosure, as shown in FIG. 6, the storage tray 240 is in a plate shape, and the plurality of first positioning holes 241 are circumferentially provided on the edge of the storage tray 240. To facilitate the user to adjust the angle and position of the guiding member, in the present embodiment, the first positioning holes 241 are also provided to penetrate through the edge of the storage tray 240. It should be noted that the width of the through part should be smaller than the diameter of the first positioning holes 241 to ensure the locking and fixing effect. In actual use, the user can install by the cooperation of the elastic deformation of the guiding member itself and the elastic deformation of the first positioning holes 241.

In the present embodiment, in order to achieve detachably installing the storage tray 240, the mounting pillar 242 is fixedly provided on the storage tray 240 along a preset angle. Correspondingly, a connecting pile 215 is provided on the cylinder 210. The mounting pillar 242 is detachably connected to the connecting pile 215 to meet the requirements of replacing or removing the optional storage tray 240.

Based on the above embodiments, in order to further improve the installation stability of the storage tray 240 and achieve a more secure locking effect on the guiding member, as shown in FIG. 6, in the present embodiment, a positioning plate 216 is provided on a side of the cylinder 210 corresponding to the connecting pile 215. The positioning plate 216 is arranged perpendicular to the bottom plate of the cylinder 210 and is correspondingly connected to the connecting pile 215. A second positioning hole 217 is provided on the positioning plate 216. The diameter of the second positioning hole 217 is the same as the diameter of the first positioning holes 241, and can also achieve the effect of engaging and fixing the guiding member 230.

Correspondingly, an installation plate 243 is also fixedly provided at the end of the mounting pillar 242. When installed, the installation plate 243 is arranged parallel to the bottom plate of the cylinder 210. A clamping groove 244 is arranged on the installation plate 243, and the clamping groove 244 corresponds to the positioning plate 216. When the storage tray 240 is installed on the cylinder 210, the installation plate 243 is installed corresponding to the bottom plate of the cylinder 210, and the positioning plate 216 passes through the clamping groove 244 and is engaged with the clamping groove 244.

In actual use, after the installation plate 243 is combined and connected with the cylinder 210, when the guiding member 230 penetrates the second positioning hole 217, the guiding member 230 itself forms a limit to the installation plate 243, limiting the vertical position of the installation plate 243. Therefore, the combination of the mounting pillar 242 and the connecting pile 215 is locked. At the same time, the engagement of the guiding member 230 through the second positioning hole 217 initially limits the position of the guiding member 230. After the guiding member 230 penetrates the first positioning holes 241, the end of the guiding member 230 can be completely locked and the direction is completely fixed. Through the cooperation between the guiding member 230, the positioning plate 216, the installation plate 243, and the storage tray 240, the stability of the connections is ensured, and the guiding and fixing effect of the guiding member 230 is provided.

In another possible implementation of the present disclosure, as shown in FIG. 1, the fan atomization assembly 100 also includes fan blades 130. The fan blades 130 are a structure having an electrically driven motor and a fan blade structure, and used to generate wind in a preset direction. When the outdoor misting fan is installed, the fan blades 130 and the atomizer 110 are arranged opposite to each other, so that the water mist can be mixed in the wind to provide a cooling feeling for the user. In the present embodiment, since the battery 300 is disposed inside the cylinder 210, the battery 300 is ensured to have a large capacity and be electrically connected to the fan blades 130 and the atomizer 110 at the same time to support the functions.

In addition, the fan atomization assembly also includes a control element 140. The control element 140 is embedded in the lower housing 120. The control element 140 can be a controllable circuit board. In addition, a power interface can also be provided. On the lower housing 120, the controllable circuit board is installed with a preset hollow window structure to achieve the effect of easy operation, installation and fixation. In the present embodiment, the control element 140 should be electrically connected to the atomizer 110, the fan and the battery 300 to achieve the effect of controlling the corresponding functional components.

Furthermore, in another implementation of the present disclosure, as shown in FIG. 1, the fan atomization assembly 100 further includes a core cylinder 150, a front ventilation hood 160, a rear ventilation hood 170 and an upper housing 180. The upper housing 180 is adapted to the lower housing 120 and can be relatively buckled, and in actual setting, the upper housing 180 and the lower housing 120 are detachably snap-connected at relative positions. The core cylinder 150 is used to fix the atomizer 110 and the fan blades 130, and in installation, the atomizer 110 and the fan blades 130 are fixedly arranged on both ends of the core cylinder 150, respectively, to achieve the effect of forming a wind with misting when in use.

The front ventilation hood 160 is sleeved on one end of the core cylinder 150, and the rear ventilation hood 170 is sleeved on the other end of the core cylinder 150. The front ventilation hood 160 and the rear ventilation hood 170 are configured to protect the atomizer 110 and the fan blades 130 while ventilation, thereby preventing debris from entering the core cylinder 150 and affecting the normal use of the outdoor misting fan. During actual installation, the relative parts of the front ventilation hood 160 and the rear ventilation hood 170 are engaged and connected fixedly install the core cylinder 150. Then, while the upper housing 180 and the lower housing 120 are engaged, the front ventilation hood 160 is fitted in one end between the upper housing 180 and the lower housing 120, and the rear ventilation hood 170 is fitted in another end between the upper housing 180 and the lower housing 120, thus the installation and fixation of all components in the fan atomization assembly 100 are formed.

Based on the above embodiments, the outdoor misting fan of the present disclosure uses common drinking water bottles in the prior art. Users can purchase drinking water having corresponding specification when in need and install the bottle directly on the long-endurance outdoor misting fan of the present disclosure for use. The arrangement of the cylinder 210 not only reduces the space for carry, but also increases the design capacity of the battery 300 in conjunction with the bottle body 400, which can effectively extend the battery life and meet the needs of long-term use.

Based on the above embodiments, the present disclosure also provides a cooling device, which includes the outdoor misting fan described in any one of the above embodiments. The outdoor misting fan includes: a fan atomization assembly, an installation assembly, and a battery. The fan atomization assembly includes an atomizer and a lower housing. The installation assembly includes: a cylinder, a clamping piece, and a guiding member. The cylinder is hollow inside and has a sealed outer wall, and one end of the cylinder is fixedly connected to the lower housing. The clamping piece is an elastic clamping piece, and the clamping piece is fixedly sleeved on an outer side of the cylinder corresponding to the lower housing. The clamping piece is used to connect a bottle body, and the cylinder is sleeved inside the bottle body. The bottle body is used as a handle and a base. The guiding member is arranged on the outer side of the cylinder, and has one end connected to the atomizer. The battery is arranged inside the cylinder, and is electrically connected to the fan atomization assembly. The present disclosure provides a hollow cylinder with a sealed outer wall, and provides an elastic clamping piece on the outer side of the cylinder corresponding to the lower housing of the fan atomization assembly. The outdoor misting fan can be adapted to various types of water bottles through the elastic clamping piece, and the cylinder can be directly placed in the water bottle when assembled, thereby increasing the installation space of the battery. Users do not need to carry the bottle when carrying the outdoor misting fan, and drinking water bottles sold on the market can be adapted and installed. The installed bottle can be used directly as a handle. The internal cylinder not only increases the installation space of the battery, but also facilitates the guiding member to obtain water. The outdoor misting fan is portable and is convenient for outdoor use and obtaining water, meeting the needs of users for long-term use.

In summary, the present disclosure provides an outdoor misting fan and a cooling device, the outdoor misting fan includes: a fan atomization assembly, an installation assembly, and a battery. The fan atomization assembly includes an atomizer and a lower housing. The installation assembly includes: a cylinder, a clamping piece, and a guiding member. The cylinder is hollow inside and has a sealed outer wall, and one end of the cylinder is fixedly connected to the lower housing. The clamping piece is an elastic clamping piece, and the clamping piece is fixedly sleeved on an outer side of the cylinder corresponding to the lower housing. The clamping piece is used to connect a bottle body, and the cylinder is sleeved inside the bottle body. The bottle body is used as a handle and a base. The guiding member is arranged on the outer side of the cylinder, and has one end connected to the atomizer. The battery is arranged inside the cylinder, and is electrically connected to the fan atomization assembly. The present disclosure features a hollow, sealed cylinder with an elastic clamping piece positioned on the exterior, corresponding to the location of the lower housing in the fan atomization assembly. This design allows the elastic clamping piece to adapt to various types of water storage bottles, and during assembly, the cylinder is directly placed inside the water storage bottle. This configuration increases the available space for the battery. Users do not need to carry a dedicated bottle when using the portable outdoor misting fan, as commercially available water bottles can be easily fitted and used as a handle. The internal cylinder not only provides additional space for the battery but also facilitates water extraction through the integrated guiding member. Consequently, the portable outdoor misting fan is both convenient to carry and use outdoors, enabling easy access to water sources and meeting the users' needs for extended usage.

It should be understood that the application of the present disclosure is not limited to the above embodiments. Those skilled in the art can make improvements or modifications based on the above descriptions. All these improvements and modifications should fall within the protection scope of the appended claims of the present disclosure.

What is claimed is:

1. An outdoor misting fan, comprising:
a fan atomization assembly, the fan atomization assembly comprising an atomizer and a lower housing;
an installation assembly, the installation assembly comprising:
a cylinder that is hollow inside and has a sealed outer wall, and one end of the cylinder is fixedly connected to the lower housing;
a clamping piece that is an elastic clamping piece, and is fixedly sleeved on an outer side of the cylinder corresponding to the lower housing, the clamping piece is configured to be connected with a bottle body, the cylinder is sleeved inside the bottle body, and the bottle body is used as a handle and a base; and
a guiding member that is arranged on the outer side of the cylinder and has one end connected to the atomizer; and
a battery that is sleeved inside the cylinder and is electrically connected to the fan atomization assembly.

2. The outdoor misting fan according to claim 1, wherein a plurality of first mounting tenons protrude from an inner side of the clamping piece, and the plurality of first mounting tenons are circumferentially arranged along a first preset angle and spaced with a preset distance; or
a plurality of second mounting tenons protrude from the inner side of the clamping piece, and the plurality of second mounting tenons are continuously arranged along a second preset angle; or
a plurality of third mounting tenons protrude from the inner side of the clamping piece, and the plurality of third mounting tenons are arranged in an array along a third preset angle.

3. The outdoor misting fan according to claim 1, wherein the lower housing comprises a mounting tube, the cylinder is sleeved in the mounting tube, and a mounting groove is provided in the lower housing corresponding to the mounting tube, and the mounting groove is continuously arranged along an intersecting curved surface between the lower housing and the mounting tube;
a limiting plate is arranged on one end of the cylinder corresponding to the lower housing, and the limiting plate protrudes outward from the one end of the cylinder, an extending portion is formed by bending an edge of the limiting plate, the limiting plate, the extending portion and the cylinder are formed integrally; and
latch teeth are arranged on the extending portion, and the latch teeth are engaged in the mounting groove.

4. The outdoor misting fan according to claim 3, wherein a diameter of the extending portion is the same as a diameter of the mounting tube, and a plurality of locking grooves are circumferentially provided on an inner side of the extending portion;
a plurality of latch tenons are provided on an outer side of the clamping piece, and the latch tenons are correspondingly fitted in each locking groove, and one side of the latch tenons is in contact with an end of the mounting tube; and
the latch teeth are formed by bending edges of the locking grooves, and a shape of the mounting groove is adapted to a shape of the latch teeth.

5. The outdoor misting fan according to claim 3, wherein a plurality of limiting tenons are provided in the lower housing corresponding to the limiting plate, and the plurality of limiting tenons are engaged with a side of the limiting plate away from the extending portion.

6. The outdoor misting fan according to claim 1, wherein the installation assembly further comprises:
a storage tray, a mounting pillar is arranged on one side of the storage tray, and the mounting pillar is removably connected to a connecting pile arranged at an end of the cylinder; and
the storage tray is in a plate shape, and a plurality of first positioning holes are circumferentially provided on the storage tray, the plurality of first positioning holes are arranged through an edge of the storage tray, and the first positioning holes are configured to fix the guiding member.

7. The outdoor misting fan according to claim 6, wherein a positioning plate is arranged on a side of the cylinder corresponding to the connecting pile, the positioning plate is arranged perpendicularly to a bottom plate of the cylinder, and a second positioning hole is arranged on the positioning plate, the second positioning hole is configured to fix the guiding member; and
an installation plate is arranged on one end of the mounting pillar, the installation plate is arranged parallel to the bottom plate of the cylinder, and a clamping groove is arranged on the installation plate, when the connecting pile is connected to the mounting tube, the positioning plate penetrates and engages with the clamping groove.

8. The outdoor misting fan according to claim 1, wherein the fan atomization assembly further comprises:
fan blades that are arranged opposite to the atomizer, and the battery is electrically connected to the fan blades and the atomizer, respectively; and
a control element that is fitted and arranged on the lower housing, and the control element is electrically connected to the atomizer, the fan blades, and the battery.

9. The outdoor misting fan according to claim 8, wherein the fan atomization assembly further comprises:
a core cylinder, the atomizer, and the fan blades are fixedly arranged on both ends of the core cylinder;
a front ventilation hood that is arranged on one end of the core cylinder;
a rear ventilation hood that is arranged on another end of the core cylinder, and the rear ventilation hood is engaged with the front ventilation hood;
an upper housing that is buckled and matched with the lower housing; the front ventilation hood is fitted in one end between the upper housing and the lower housing; the rear ventilation hood is fitted in another end between the upper housing and the lower housing.

10. A cooling device, wherein the cooling device comprises the outdoor misting fan according to claim 1.
